(19) United States
(12) Patent Application Publication
(10) Pub. No.: US 2003/0198421 A1
(43) Pub. Date: Oct. 23, 2003

(54) Tapered rolling bearing

(75) Inventors: Andrea Serafini, Pinerolo (IT); Andrea Griseri, Torino (IT)

Correspondence Address: MERCHANT & GOULD PC, P.O. BOX 2903, MINNEAPOLIS, MN, 55402-0903, US

(73) Assignee: SKF INDUSTRIE S.p.A., Torino (IT)

(21) Appl. No.: 10/385,231

(22) Filed: Mar. 10, 2003

(30) Foreign Application Priority Data
Apr. 22, 2002 (IT) TO2002A000346

(51) Int. Cl. F16C 33/58

(52) U.S. Cl. 384/571

(57) ABSTRACT

Tapered rolling bearing (1) which presents an inner race (2) which is provided with a guiding rim (5) along one of its own sides; a ground rolling surface (7) which is radially obtained outside the inner race (2) and which is axially delimited by the guiding rim (5); a crown of tapered rollers (4), each of which is suitable for rolling in contact with the rolling surface (7) and which is extremely close to the guiding rim (5); and a grinding relief (8), which is obtained between the rolling surface (7) and the guiding rim (5) in order to permit the grinding of the rolling surface (7) itself, and which is provided with an annular outlet edge (9) which confines with the rolling surface (7); the annular outlet edge (9) of the grinding relief (8) being arranged at a determined distance from the rolling surface (7), said distance being measured transverse to the rolling surface (7) itself.

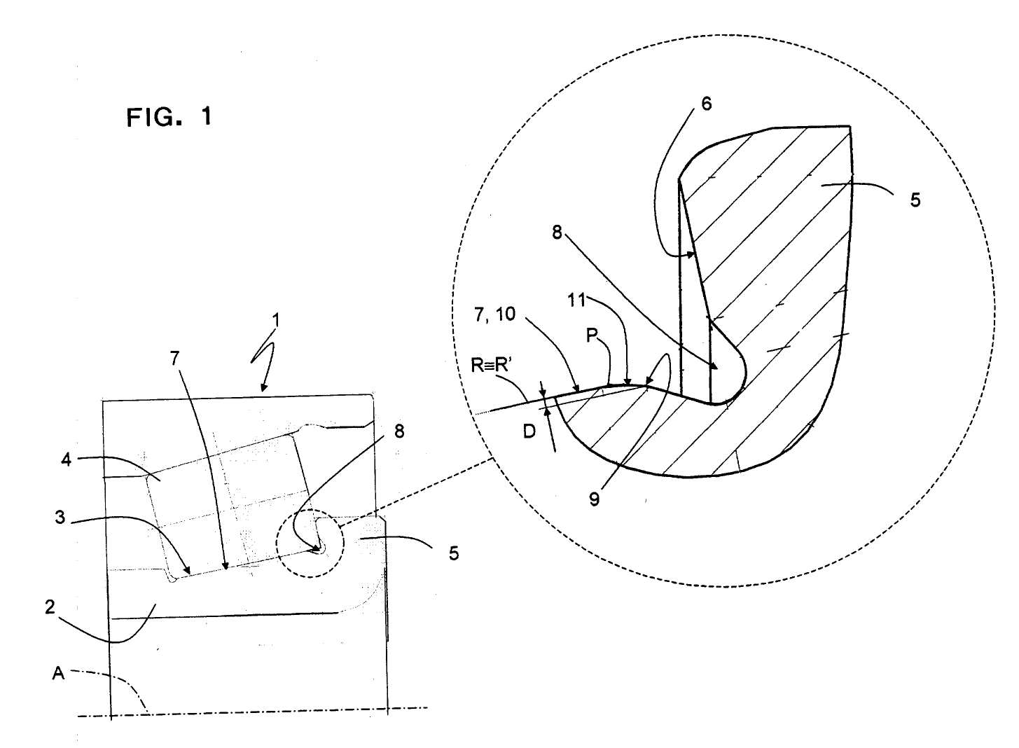

The present invention relates to a The present invention relates to a tapered rolling bearing.

Tapered rolling bearings of a well-known kind comprise:

an inner race which is provided with a guiding rim along one of its own sides;

a tapered rolling track which is radially obtained outside the inner race and which is axially delimited by the guiding rim and;

a crown of tapered rollers, each of which is suitable for rolling in contact with the rolling track and which is extremely close to the guiding rim.

In the kinds of tapered rolling bearings which have just been described above, the tapered rolling track is provided with a ground rolling surface and a grinding relief, which is obtained between the rolling surface and the guiding rim in order to permit the grinding of the rolling surface itself, and which presents, from the part of the rolling surface, an annular outlet edge which defines a discontinuity between the rolling surface itself and the inside of the outlet edge.

Tapered rolling bearings of the type described above are generally used for bearing radial kinds of loads and, to a lesser extent, axial kinds of loads, but in the case that they are subjected to angular momentum, or rather to the kind of stress for which they were not designed, it has been discovered that the anomalous increase of the load with regard to the rollers, and by reflex, the pressure of the rollers themselves on the annular outlet edge results in greater wear and tear on the rollers and, consequently, a decrease in the lifetime of the tapered rolling bearings themselves.

The aim of the present invention is to produce a tapered rolling bearing which is totally free of the disadvantages described above and which comprises:

an inner race which is provided with a guiding rim along one of its own sides;

a ground rolling surface which is radially obtained outside the inner race and which is axially delimited by the guiding rim;

a crown of tapered rollers, each of which is suitable for rolling in contact with the rolling surface and which is extremely close to the guiding rim and

a grinding relief which is obtained in order to permit surface machining between the rolling surface and the guiding rim in order to permit surface machining of the rolling surface itself, and which is provided with an annular outlet edge which confines with the rolling surface;

the tapered rolling bearing being characterised by the fact that the annular outlet edge of the grinding relief is arranged in a position which is lower in comparison to the rolling surface, and which is at a determined distance from the rolling surface, which distance is measured transverse to the rolling surface itself.

The present invention will now be described with reference to the attached drawing, which illustrates, in axial section and with some parts removed for reasons of clarity, a non-limiting form of embodiment of a tapered rolling bearing according to the present invention.

With reference to the attached drawing, the number 1 indicates a tapered rolling bearing in its entirety, which presents a longitudinal axis A, and which comprises an inner race 2, a tapered rolling track 3 which is radially obtained outside the inner race 2, a crown of tapered rollers 4 which are suitable for rolling on the track 3, and a guiding rim 5, which is axially delimited towards the outside of the track 3, and which presents a flat annular inside surface 6 which is axially arranged in close proximity to the rollers 4 themselves.

The tapered rolling bearing 1 also comprises a ground rolling surface which defines the track 3 and a grinding relief 8, the latter being obtained between the track 3 itself and the rim 5 in order to permit the grinding of the surface 7, and which is provided with an annular outlet edge 9 which confines with the rolling surface 7 itself.

In particular, the rolling surface 7 comprises a substantially tapering portion which is arranged in contact with the rollers 4, and a curved connecting portion 11, which serves to connect the annular edge 9 and the portion 10 itself, and which arranges the annular edge 9 itself in a position which is lower than the surface 7, and which is at a determined distance D from the surface 7, said distance being measured transverse to the surface 7 itself.

In correspondence with each joining point P of the portion 10 with the curved portion 11, a line R which is at a tangent at that point P to the portion 10 perfectly coincides with the line R′ which is at a tangent at the same point P to the curved portion 11, and so the passage between the portion 10 and the curved portion 11 occurs without any discontinuity at all. Consequently, any kind of increase whatsoever in terms of load on the tapered rolling bearing 1, and in particular any kind of load which is different from the kind of load for which the tapered rolling bearing 1 was initially designed, is translated into an increase in pressure between the rollers 4 and the track 3, but this will not cause any damage whatsoever to the rollers 4 themselves, as said rollers 4 will continue to roll along a continuous surface 7.

It is intended that the present invention should not be limited to the form of embodiment which is herein described and illustrated, which is to be considered as a form of embodiment of a tapered rolling bearing, which might be subject to further modifications relating to the shape and arrangements of the parts, as well as details pertaining to construction and assembly.

1. Tapered rolling bearing (1), which comprises:
an inner race (2) which is provided with a guiding rim (5) along one of its own sides;
a ground rolling surface (7) which is radially obtained outside the inner race (2) and which is axially delimited by the guiding rim (5);
a crown of tapered rollers (4), each of which is suitable for rolling in contact with the rolling surface (7) and which is extremely close to the guiding rim (5) and
a grinding relief (8) which is obtained in order to permit surface machining between the rolling surface (7) and the guiding rim (5) in order to permit surface machining of the rolling surface (7) itself, and which is provided with an annular outlet edge (9) which confines with the rolling surface (7);
the tapered rolling bearing (1) being characterised by the fact that the annular outlet edge (9) of the grinding relief (8) is arranged in a position which is lower in comparison to the rolling surface (7), and which is at a determined distance (D) from the rolling surface (7), which distance is measured transverse to the rolling surface (7) itself.

2. Tapered rolling bearing according to claim 1, characterised by the fact that the rolling surface (7) comprises a substantially tapered portion (10) and a curved connecting portion (11) which is arranged between the substantially tapered portion (10) and the said annular outlet edge (9); the curved connecting portion (11) and the substantially tapering portion (10) presenting the same line (R, R′) which is at a tangent in correspondence with each joining point (P).

3. Tapered rolling bearing according to claim 2, characterised by the fact that the curved connecting portion (11) is produced together with the said substantially tapering portion (10) by means of the said surface machining.

4. Tapered rolling bearing according to claim 3, characterised by the fact that the said surface machining is a grinding surface machining.
